(19) United States
(12) Patent Application Publication
(10) Pub. No.: US 2010/0192168 A1
(43) Pub. Date: Jul. 29, 2010

(54) DISC DEVICE

(75) Inventor: Yuichiro Suzui, Tokyo (JP)

Correspondence Address: BIRCH STEWART KOLASCH & BIRCH, PO BOX 747, FALLS CHURCH, VA, 22040-0747, US

(73) Assignee: MITSUBISHI ELECTRIC CORPORATION, Tokyo (JP)

(21) Appl. No.: 12/671,157

(22) PCT Filed: Jun. 13, 2008
(86) PCT No.: PCT/JP2008/001531

§ 371 Date: Jan. 28, 2010

(30) Foreign Application Priority Data
Oct. 31, 2007 (JP) 2007-283430

(51) Int. Cl. G11B 17/04

(52) U.S. Cl. 720/601; G9B/17.013

(57) ABSTRACT

A disc device that performs insertion and ejection of a disc into and from a main unit by using a conveying roller includes a slider member for performing an operation of upwardly and downwardly moving the above-mentioned conveying roller, an operation of upwardly and downwardly moving an arm clamp for pressing the above-mentioned disc onto a turntable to hold the above-mentioned disc, and an operation of locking and unlocking a playback base on which the above-mentioned turntable is disposed. An engagement part for engaging with both an engagement part of the above-mentioned arm clamp and an engagement part of the above-mentioned playback base at a point is disposed in the above-mentioned slider member.

### FIELD OF THE INVENTION

The present invention relates to a disc device that performs insertion and ejection of a disc into and from a main unit by using a conveying roller.

### BACKGROUND OF THE INVENTION

In a conventional disc device, a cam for conveying roller rise and fall, a cam for arm clamp rise and fall, and an engagement groove for playback base lock are disposed for their respective exclusive uses in a slider member which performs an operation of upwardly and downwardly moving a conveying roller, an operation of upwardly and downwardly moving an arm clamp so as to press a disc onto a turntable and hold the disc, and an operation of locking and unlocking a playback base on which the turntable is disposed, as shown in, for example, patent reference 1.

[Patent reference 1] JP,2003-123358,A

However, because a part of the playback base which is locked differs from a part of the arm clamp at a risen position which is supported in the above-mentioned structure of the slider member of the conventional disc device, the relative rise in height of the arm clamp with respect to the playback base is easily affected by the attitude of the slider member due to backlash within the disc device and variations in the finished size of each cam part. When the relative rise in height of the arm clamp is small, that is, when the gap disposed between the playback base and the arm clamp is narrow under the above-mentioned influence, the disc which is conveyed to a playback position comes into contact with parts on the arm clamp and the playback base, and may damage the disk surface. Furthermore, it is necessary to form the cams used for the operations in the single component and therefore the slider member increases in size in a direction of the depth of the disc device, and this results in increase in the size of the disc device.

The present invention is made in order to solve the above-mentioned problems, and it is therefore an object of the present invention to provide a disc device which can certainly ensure a required gap between a playback base and a arm clamp thereof, and which can achieve downsizing thereof.

### DISCLOSURE OF THE INVENTION

In accordance with the present invention, there is provided a disc device including a slider member for performing an operation of upwardly and downwardly moving a conveying roller, an operation of upwardly and downwardly moving an arm clamp for pressing a disc onto a turntable to hold the disc, and an operation of locking and unlocking a playback base on which the turntable is disposed, in which an engagement part for engaging with both an engagement part of the above-mentioned arm clamp and an engagement part of the above-mentioned playback base at a point is disposed in the above-mentioned slider member.

In accordance with the present invention, because the engagement part for engaging with both the engagement part of the arm clamp and the engagement part of the playback base at a point is disposed in the slider member, the height positions of the arm clamp and the playback base are determined by the engagement among the engagement parts. More specifically, the positions of the pins of the arm clamp and the playback base are determined in the single cam groove. the disc device is not affected by variations in the finished size of each cam groove and the attitude of the sliding member due to backlash, which affect conventional disc devices. Furthermore, because the disc device is constructed in such a way that the two engagement parts of the arm clamp and the playback base are engaged with the engagement part at the point of the slider member, there is provided an advantage of being able to prevent upsizing of the device.

### BRIEF DESCRIPTION OF THE FIGURES

FIG. 1 is a plan view showing only a main part in a disc insertion standby state of a disc playback device in accordance with Embodiment 1 of the present invention;

FIG. 2 is a right side view of FIG. 1;

FIG. 3 is a plan view showing a state in which a disc is inserted;

FIG. 4 is a right side view of FIG. 3;

FIG. 5 is a plan view showing a disc playback state;

FIG. 6 is a right side view of FIG. 5;

FIG. 7 is an enlarged perspective view showing only the main part in the disc insertion standby state;

FIG. 8 is an enlarged perspective view showing only the main part in the disc playback state;

FIG. 9 is an enlarged perspective view showing only a main part in a disc insertion standby state of a disk playback apparatus in accordance with Embodiment 2 of the present invention; and

FIG. 10 is an enlarged perspective view showing only the main part in a disc playback state.

### PREFERRED EMBODIMENTS OF THE INVENTION

Hereafter, in order to explain this invention in greater detail, the preferred embodiments of the present invention will be described with reference to the accompanying drawings.

### Embodiment 1

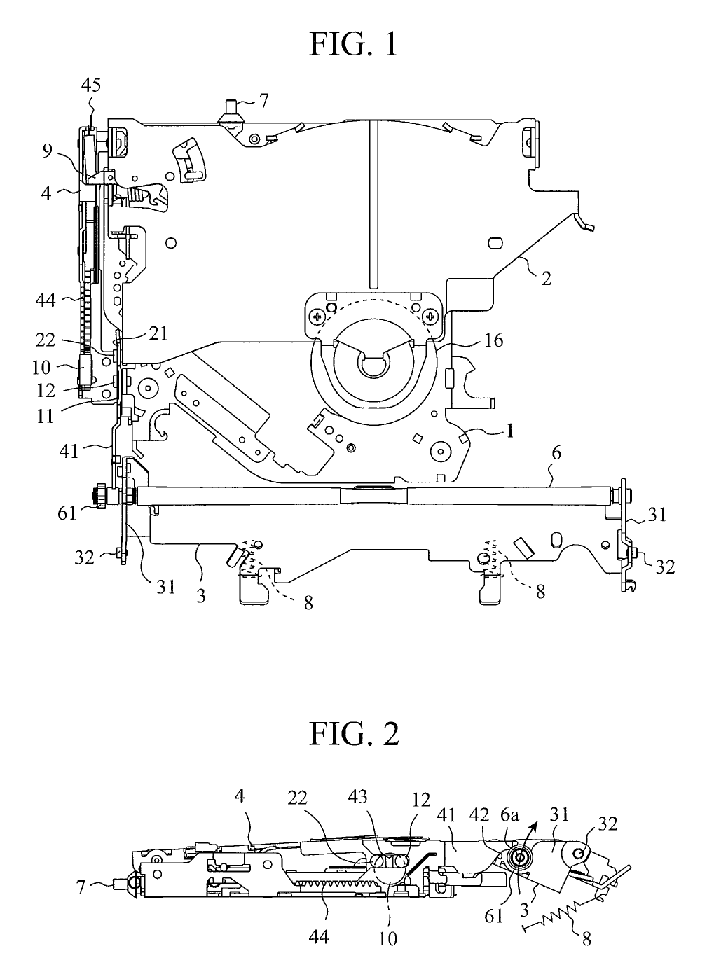

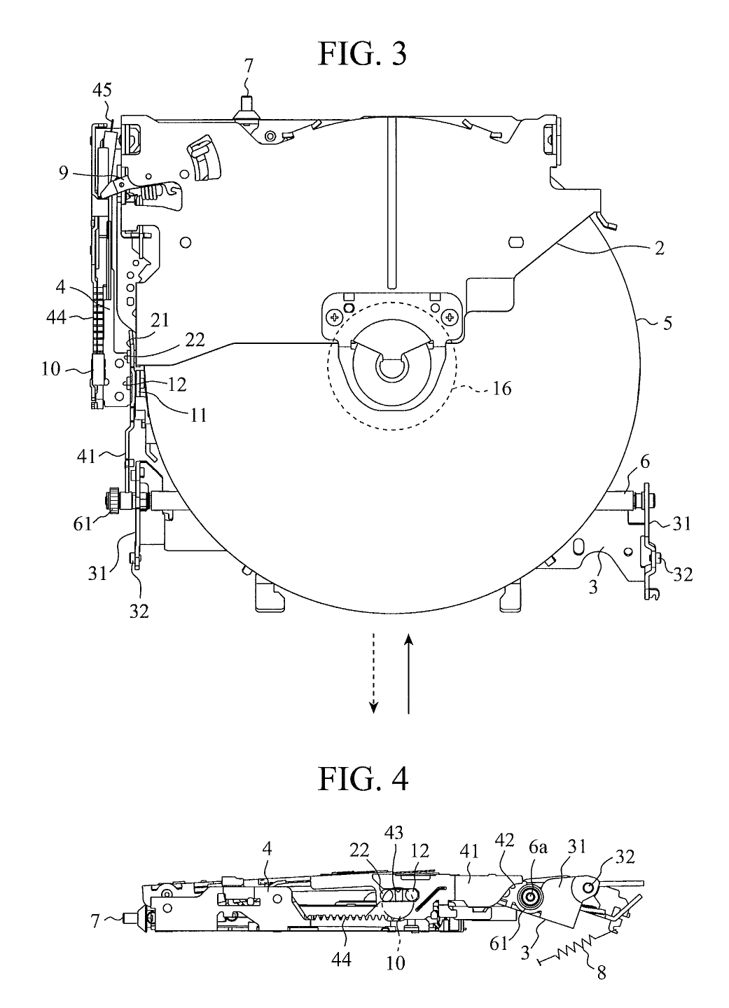

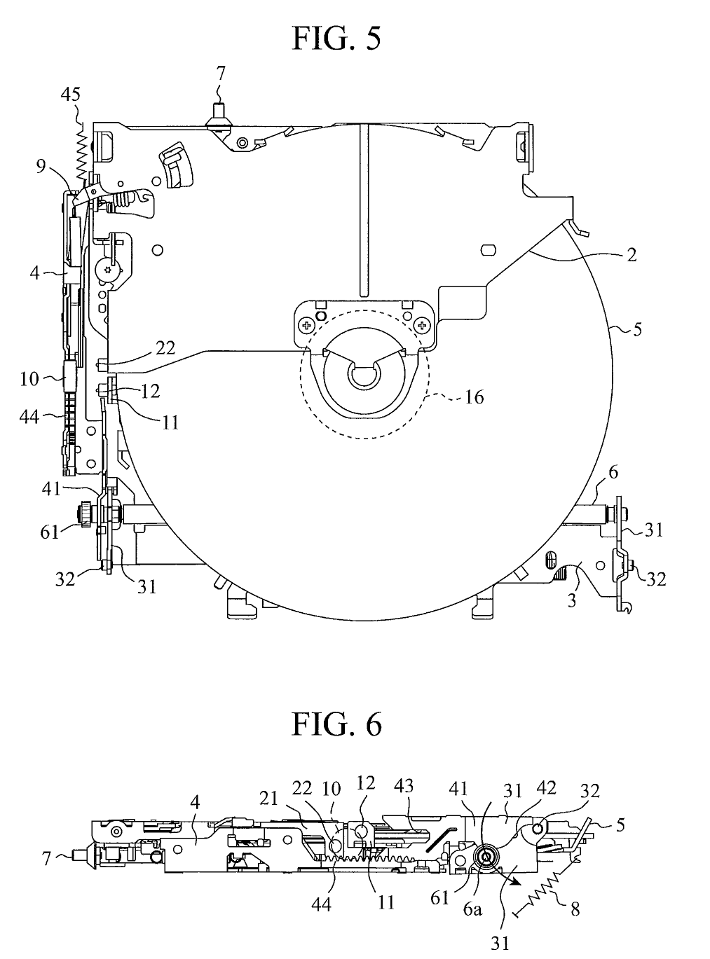

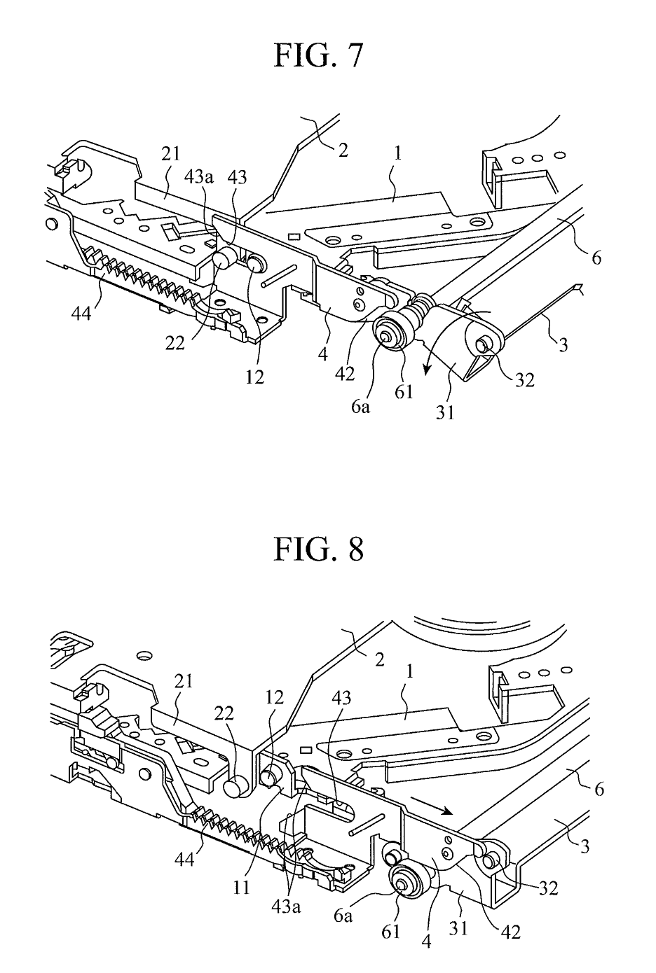

FIG. 1 is a plan view showing only a main part in a disc insertion standby state of a disc playback device in accordance with Embodiment 1 of the present invention, FIG. 2 is a left side view of FIG. 1, FIG. 3 is a plan view showing in a state in which a disc is inserted, FIG. 4 is a right side view of FIG. 3, FIG. 5 is a plan view showing a disc playback state, FIG. 6 is a right side view of FIG. 5, FIG. 7 is an enlarged perspective view showing only the main part in the disc insertion standby state, and FIG. 8 is an enlarged perspective view showing only the main part in the disc playback state.

The disc device in accordance with Embodiment 1 of the present invention is provided with a playback base 1, an arm clamp 2, a roller base member 3, and a slider member 4. The playback base 1 is provided with a turntable 16, and is disposed in such a way as to be locked to and unlocked from a not-shown chassis base plate and is supported to the chassis base plate by way of a buffer member (not shown) locked to a buffer member locking member 7 when unlocked from the chassis base plate in such a way as to be able freely shake. The arm clamp 2 is rotatably supported to the playback base 1.

The roller base member 3 has side plates 31 and 31 which are extending in a direction substantially perpendicular thereto at both ends thereof, and which are rotatably supported, via axes 32 and 32, to the not-shown chassis base plate. Both ends of a disc conveying roller 6 are rotatably supported to the side plates 31 and 31 respectively. At an end of the disc conveying roller 6 penetrating through one of these side plates 31, a gear 61 engaged with and released from a driving gear disposed on the not-shown chassis base plate is disposed. Furthermore, between the roller base member 3 and the not-shown chassis base plate, springs 8 each for always applying a rotational force in a direction of an arrow shown in FIG. 2 to the roller base member 3 are disposed so as to cause the disc conveying roller 6 to move upwardly.

The slider member 4 is supported to the not-shown chassis base plate in such a way as to be able to move along one of the side plates 31 in forward and backward directions. Between this slider member 4 and the not-shown chassis base plate, a spring 45 for pushing this slider member backwardly is disposed. A disc insertion detecting lever 9 is in contact with the slider member 4 in such a way as to move this slider member 4 forwardly (in a direction of the front side of the disc device) when detecting insertion of a disc 5 and is then rotated.

Furthermore, a front end of a side plate 41 extending substantially perpendicularly from the slider member 4, the slide plate being disposed close to the above-mentioned side plate 31, has a cam part 42 for downwardly pushing the disc conveying roller 6 against the spring forces of the springs 8, and a back end of this side plate 41 has a cam groove 43 into which a pin 12 disposed on an outer surface of a side plate 11 of the playback base 1 and a pin 22 disposed on an outer surface of a side plate 21 of the arm clamp 2 are led. The slider member 4 also has a rack 44 extending in forward and backward directions and in parallel with the cam groove 43. The driving gear 10 disposed on the not-shown chassis base plate is engaged with and released from this rack 44.

Next, the operation of the disc device will be explained. First, in the disc insertion standby state shown in FIGS. 1 and 2, the slider member 4 retracts (moves backwardly) while being pulled by the spring force of the spring 45, and is held at the standby position. As a result, the rack 44 is released from the driving gear 10, and the cam part 42 of the slider member 4 does not act on the disc conveying roller 6. Therefore, the roller base member 3 receives the spring forces of the springs 8 to rotate about the axis 32 of the side plate 31 in a direction of an arrow, and then holds the disc conveying roller 6 at the disk conveying position. At this time, the gear 61 disposed at the end of the disc conveying roller 6 is engaged with the driving gear disposed on the not-shown chassis base plate.

When the disc 5 is inserted in the disc insertion standby state shown in FIGS. 1 and 2, the driving gear disposed on the not-shown chassis base plate starts rotating according to a signal from a not-shown detecting unit which has detected this insertion, and the disc conveying roller 6 then rotates via the gear 61 which is engaged with this driving gear. The inserted disc 5 is then conveyed with being sandwiched between the disc conveying roller 6 and a not-shown disk guide, and is further conveyed until it is held at a predetermined position as shown in FIGS. 3 and 4, i.e. onto the turntable 16.

After the disc 5 is conveyed to the predetermined position, a movement of the disc insertion detecting lever 9, which is pushed and moved by this conveyed disc, from the position of FIG. 1 to the position of FIG. 3 pushes and moves the slider member 4 forwardly against the spring force of the spring 45. As a result, the rack 44 is engaged with the driving gear 10, and the slider member 4 further moves forwardly according to rotation of the driving gear 10, as shown in FIGS. 5 and 6. As the slider member moves this way, the cam part 42 disposed at the front end of the slider member 4 acts on the disc conveying roller 6 to downwardly push this conveying roller. Accordingly, the roller base member 3 rotates against the spring forces of the springs 8 in a direction of an arrow shown in FIG. 6.

On the other hand, the movement of the slider member 4 releases both the pin 12 disposed on the outer surface of the side plate 11 of the playback base 1 and the pin 22 disposed on the outer surface of the side plate 21 of the arm clamp 2 from the cam groove 43. As a result, the playback base 1 is unlocked and is held by, via the buffer member (not shown), such as a damper or a suspension spring, which is locked to, for example, the buffer member locking member 7, the not-shown chassis base plate in such a way as to be able to freely shake. The arm clamp 2 is also unlocked and rotated by the action of the spring force of a not shown twisting spring to place the disc 5 on the turntable 16 and push the disc toward the turntable from the top of the disc, thereby holding the disc. Therefore, vibrations from a vehicle body equipped with this disc device can be prevented from propagating to the playback base 1 by the buffer member (not shown), and the disc 5 can be certainly held on the turntable 16. As a result, playback of the disc is carried out with stability.

When the disc device shifts to an operation of ejecting the disc 5 after ending the playback of the disc 5 in the above-mentioned playback state of the disc 5, the driving gear 10 starts rotating in a direction reverse to the above-mentioned direction to cause the slider member 4 to retract by way of the rack 44. When the engagement between the rack 44 and the driving gear 10 is then released, the slider member is made to retract up to the predetermined position by the spring force of the spring 45 to lead both the pin 12 disposed on the outer surface of the side plate 11 of the playback base 1 and the pin 22 disposed on the outer surface of the side plate 21 of the arm clamp 2 into the cam groove 43 of the slider member 4 and hold them. As a result, a predetermined gap is formed between the arm clamp 2 and the roller base member 3, and the disc device is placed in the disc insertion standby state shown in FIGS. 1 and 2.

As mentioned above, because the disc device in accordance with the present invention is constructed in such a way that both the pin 12 disposed on the outer surface of the side plate 11 of the playback base 1 and the pin 22 disposed on the outer surface of the side plate 21 of the arm clamp 2 are engaged with the single cam groove 43 disposed in the slider member 4, a preset gap can be certainly ensured between the playback base 1 and the arm clamp 2 by virtue of the width of the cam groove 43 and the diameters of the pins 12 and 22 without being affected by the attitude of the slider member 4 and the position and size of the cam part 42, which affect conventional structures.

Therefore, the present embodiment can prevent the gap between the playback base 1 and the arm clamp 2 from becoming small under the influence of the attitude of the slider member 4 and the position and size of the cam, thereby preventing scratches from occurring on the disc surface due to contact with the turntable for disc placement, which is disposed on the arm clamp, or the like at the time when the disk is being conveyed.

Furthermore, because the operation of upwardly and downwardly moving the arm clamp, and the operation of locking and unlocking the playback base are carried out by using the single cam groove formed in the slider member, it becomes unnecessary to dispose a cam groove for exclusive use in each member, such as formed in a conventional structure, and the shape of the slider member can be reduced and the movable range of the slider member can also be reduced. Therefore, there is provided an advantage of being able to downsize the disc device.

### Embodiment 2

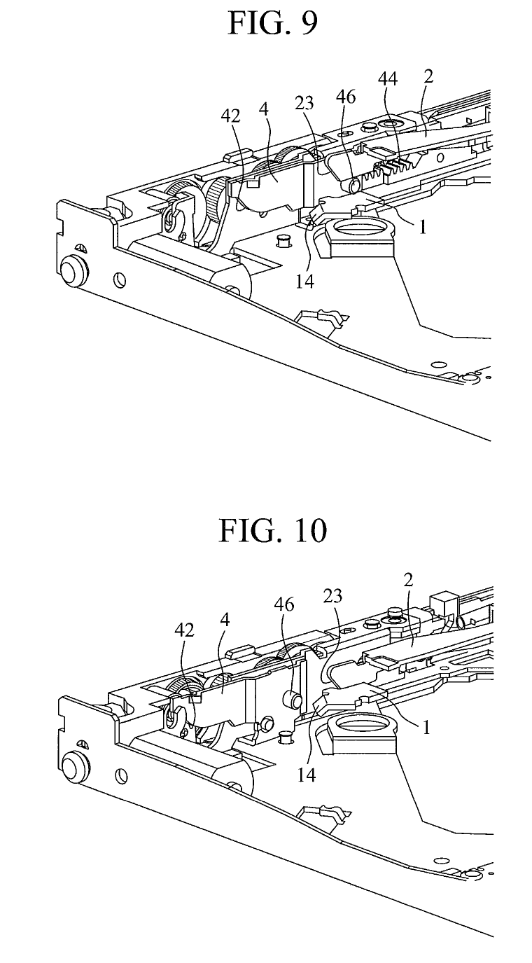

In above-mentioned Embodiment 1, the example in which the single cam groove 43 is formed in the slider member 4 is explained. As an alternative, one pin 46 can be formed in the slider member 4, and cam-shaped engagement parts 14 and 23 with and from which this pin is engaged and released can be formed on the playback base 1 and the arm clamp 2 respectively. In this case, the same operation effects as those in above-mentioned embodiment can be acquired. As the pin 46, a projection which is formed on the slider member by, for example, bending a sheet metal material can be disposed. FIGS. 9 and 10 are configuration diagrams showing this Embodiment 2. FIG. 9 is an enlarged perspective view showing only the main part in the disc insertion standby state, and FIG. 10 is an enlarged perspective view showing only the main part in the disc playback state.

As shown in FIG. 9, when the slider member 4 retracts to a predetermined position on a side of the back of the main unit in the disc insertion standby state, the pin 46 is guided to the cam-shaped engagement parts 14 and 23 and enters between the playback base 1 and the arm clamp 2. As a result, the playback base 1 is pushed downwardly, the arm clamp 2 is pushed upwardly, and a gap which allows insertion and ejection of a disc 5 thereinto and therefrom is certainly ensured between the playback base 1 and the arm clamp by virtue of the diameter of the pin 46.

On the other hand, as shown in FIG. 10, when the disc device enters the disc playback state and the slider member 4 moves forwardly to a predetermined position on a side of the front of the main unit, the pin 46 is released from the cam-shaped engagement parts 12 and 22 and stops acting on the playback base 1 and the arm clamp 2. As a result, the playback base 1 is unlocked and is held by, via the buffer member locked to the buffer member locking member 7, the not-shown chassis base plate in such a way as to be able to freely shake. The arm clamp 2 pushes the disc 5 placed on the turntable 16 toward the turntable to hold the disc 5. Therefore, vibrations from a vehicle body equipped with this disc device can be prevented from propagating to the playback base 1 by the buffer member, and the disc 5 can be certainly held on the turntable 16. As a result, playback of the disc is carried out with stability.

Because the cam groove 43 has an introducing guide slope 43a for guiding the pins 12 and 22 to this engagement groove at an inlet portion thereof, the engagement of the pins 12 and 22 with the cam groove 43 is carried out certainly. Furthermore, because the engagement groove 43 has a width close to the diameter of each of the pins 12 and 22, the pins 12 and 22 do not move in the engagement groove 43 even if they receive vibrations or the like. That is, because the playback base 1 and the arm clamp 2 do not vibrate, the gap which allows insertion and discharge of the disc 5 into and from the disc device is ensured certainly, and the operation of inserting and ejecting the disc 5 into and from the disc device is carried out with stability.

### INDUSTRIAL APPLICABILITY

As mentioned above, the disc device in accordance with the present invention is constructed in such a way that the engagement part for engaging with both the engagement part of the arm clamp and the engagement part of the playback base at a point is disposed in the slider member and a required gap is certainly ensured between the arm clamp and the playback base. Therefore, the disc device in accordance with the present invention is suitable for use as a small disc device which is not affected by variations in the finished size of each cam groove and the attitude of the sliding member due to backlash.

1. A disc device that performs insertion and ejection of a disc into and from a main unit by using a conveying roller, characterized in that said disc device comprises: a slider member for performing an operation of upwardly and downwardly moving said conveying roller, an operation of upwardly and downwardly moving an arm clamp for pressing said disc onto a turntable to hold said disc, and an operation of locking and unlocking a playback base on which said turntable is disposed, and characterized in that an engagement part for engaging with both an engagement part of said arm clamp and an engagement part of said playback base at a point is disposed in said slider member.

2. The disc device according to claim 1, characterized in that when the engagement part of the slider member is a groove, the engagement part of the arm clamp and the engagement part of the playback base are pins, whereas when the engagement part of said slider member is a pin, the engagement part of said arm clamp and the engagement part of said playback base are cam-shaped engagement parts.

3. The disc device according to claim 2, characterized in that at an inlet portion of the engagement groove, an introducing guide slope for guiding the pins to the engagement groove is disposed.

4. The disc device according to claim 2, characterized in that the engagement groove has a width close to a diameter of each of the pins.
